(19) United States
(12) Patent Application Publication
(10) Pub. No.: US 2010/0331516 A1
(43) Pub. Date: Dec. 30, 2010

(54) Process for Preparation of Sevelamer Carbonate

(76) Inventors: Govind Dhananjay Sathe, Mumbai (IN); Harish Kashinath Mondkar, Mumbai (IN); Tanaji Shamrao Jadhav, Mumbai (IN); Samadhan Daulat Patil, Mumbai (IN)

Correspondence Address: PHARMACEUTICAL PATENT ATTORNEYS, LLC, 55 MADISON AVENUE, 4TH FLOOR, MORRISTOWN, NJ, 07960-7397, US

(21) Appl. No.: 12/525,863

(22) PCT Filed: Apr. 6, 2009
(86) PCT No.: PCT/IN09/00226

§ 371 Date: Aug. 5, 2009

(30) Foreign Application Priority Data
Apr. 8, 2008 (IN) 00826/MUM/2008

(51) Int. Cl. C08G 65/02

(52) U.S. Cl. 528/393

(57) ABSTRACT

The present invention discloses simple process for preparation of salt of polyallylamine polymer.

### RELATED APPLICATIONS

This application claims the benefit of Indian Provisional Application No. 00826/MUM/2008 filed on 8 Apr. 2008 and PCT Application No. PCT/IN2009/000226 filed on 6 Apr. 2009.

### TECHNICAL FIELD

The present invention relates to the process for preparation of carbonate salt of amine polymers, preferably Poly(allylamine-co-N,N′-diallyl-1,3-diamino-2-hydroxypropane)carbonate Formula-I, an antihyperphosphatemic agent.

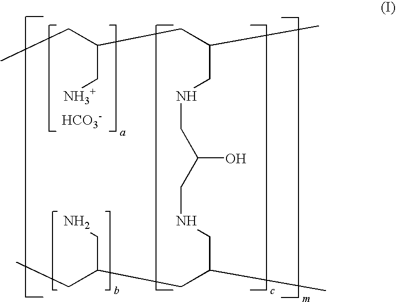

a, b=number of primary amine groups a+b=9
c=number of crosslinking groups c=1
m=large number to indicate extended polymer network

### BACKGROUND OF THE INVENTION

Sevelamer carbonate is non-absorbable polymer marketed as Renvela™ by Genzyme Corporation. It is known chemically as poly(allylamine-co-N,N′-diallyl-1,3-diamino-2-hydroxypropane) carbonate salt. It was developed as a pharmaceutical alternative to Sevelamer hydrochloride (Renagel®). Renvela™ contains Sevelamer carbonate, a non-absorbed phosphate binding crosslinked polymer, free of metal and calcium. It contains multiple amines separated by one carbon from the polymer backbone. These amines exist in a protonated form in the intestine and interact with phosphate molecules through ionic and hydrogen bonding. By binding phosphate in the dietary tract and decreasing absorption, Sevelamer carbonate lowers the phosphate concentration in the serum.

Sevelamer carbonate is an anion exchange resin with the same polymeric structure as Sevelamer hydrochloride in which carbonate replaces chloride as the counterion. While the counterions differ for the two salts, the polymer itself, the active moiety, is the same. The protonated amines can be indirectly measured as carbonate content in meq/gm. Renvela™ is used in End Stage Renal Disease (ESRD) which leads to hyperphosphatemia due to retention of phosphorous. This condition can lead to ectopic calcification. Renvela™ binds dietary phosphate in GI tract and thus controls the serum phosphate levels. The potency of Renvela™ is measured in terms of its Phosphate Binding Capacity (PBC) by Phosphate Assay (PA). Treatment of hyperphosphatemia includes reduction in dietary intake of phosphate, inhibition of intestinal phosphate absorption with phosphate binders, and removal of phosphate with dialysis. Sevelamer carbonate taken with meals has been shown to control serum phosphorus concentrations in patients with CKD who are on dialysis. Currently Sevelamer hydrochloride is used to cure hyperphosphatemia. As a consequence ESRD patients still need a high dosage of Renagel® to meet clinical end-points, leading to adverse effect such as gastrointestinal discomfort and problems with patient compliance. But systemic acidosis development or worsening of pre-existing acidosis has been reported in many patients on long term dialysis who are given Sevelamer hydrochloride (Perit Dial Int. 2002, 22, 737-738, Nephron 2002, 92, 499-500, Kidney Int. 2004, 66, S39-S45, Ren. Fail 2005, 27,143-147).

Administration of Sevelamer hydrochloride adds to metabolic acid load because the resin removes some bicarbonate or bicarbonate precursor (mainly short chain fatty acid anions) from the body and replaces it with chloride. Each molecule of chloride contributed to the body in exchange for carbonate or bicarbonate precussor is equivalent to a molecule of hydrochloric acid added to the body, so the tendency of patients on long term haemodialysis to acidosis is inevitably increased when they take Sevelamer hydrochloride. (Kidney Int., 2005; 67: 776-777)

This problem can be countered by an increase in the dialysate concentration of bicarbonate used in each dialysis session. A more fundamental solution, suitable for both dialyzed and non-dialyzed patients, would be the administration of Sevelamer free base, or any other suitable resin, not as the chloride but as body suitable counterion such as bicarbonate. Anion exchange resins have traditionally been synthesized in the chloride form, but the chloride in the current Sevelamer preparation is of no benefit to patients with renal failure. A change in the formulation of Sevelamer from its current chloride form to Sevelamer attached to bicarbonate would convert an acid load into a mild alkali load. (Cli. Sci. 1963; 24:187-200)

U.S. Pat. No. 6,858,203 relates to phosphate-binding polymers provided for removing phosphate from the gastrointestinal tract. These polymers are useful for the treatment of hyperphosphatemia.

WO 2006/050315 describes pharmaceutical compositions comprising a carbonate salt of an aliphatic amine polymer wherein the monovalent anion can prevent or ameliorate acidosis, in particular acidosis in patients with renal disease.

HPLC Ion Chromatography PA method is used for the determination of PBC of Sevelamer HCl which can be adopted for determining the carbonate content from Sevelamer carbonate (J R Mazzeo et al, J. Pharm. Biomed. Anal. 19 (1999) 911-915).

Our co-pending application number 1402/MUM/2006 dated 1 Sep. 2006 discloses process for preparation of Sevelamer HCl having phosphate binding capacity in the range of about 5.0 meq/gm to about 6.0 meq/gm and chloride content in the range of about 3.74 to about 5.60 meq/gm.

The prior art mentioned above discussed advantages of Sevelamer carbonate over Sevelamer hydrochloride thus there remains need for commercially viable and industrially useful process for the preparation of Sevelamer carbonate having consistency in phosphate binding capacity, degree of cross linking, chloride content and carbonate content.

### OBJECT OF INVENTION

The main object of the present invention is to provide carbonate salt of amine polymers having chloride content less than about 0.05%.

Another object of the present invention is to provide carbonate salt of amine polymers with consistent carbonate content and phosphate binding capacity. Another object of present invention is to provide simple process for preparation of carbonate salt of amine polymers.

It is an object of this invention is to provide a process for preparation of Sevelamer carbonate, which is devoid of additional steps during the reaction process thereby saving valuable process time, energy and the need for additional equipments and reagents.

Another object of this invention is to provide a simple process for preparation of Sevelamer carbonate, wherein the necessary routine method steps. employed in the conventional processes are completely obviated thereby making the overall process drastically simple, economical, eco-friendly, safe and faster.

Another object of the present invention is to provide process for drying carbonate salt of amine polymers for controlling loss on drying in the range of about 5 to 10%.

### SUMMARY OF INVENTION

According to one aspect of the invention there is provided process for preparation of carbonate salt of amine polymers comprising interacting allylamine compound with suitable carbonate source. In accordance with a preferred aspect the process is carried out in the same reaction vessel preferably amine polymer carbonate salt is prepared by one pot process. “one pot reaction” in the context of this invention is a strategy to improve the efficiency of a reaction whereby a reactant or set of reactants are subjected to successive chemical reactions in just one reaction vessel to get desired compound in high yield.

Another aspect of the present invention provides process for preparation of carbonate salt of amine polymers which comprises the steps of;
a) treating allylamine compound with base to obtain reaction mass;
b) adding suitable carbonate source to the obtained reaction mass to get the product.

Another aspect of the present invention provides process for preparation of Sevelamer carbonate comprising the steps of;
a) treating polyallylamine hydrochloride with base to obtain polyallylamine;
b) interacting obtained polyallylamine with suitable carbonate source to get polyallylamine carbonate;
c) crosslinking the obtained polyallylamine carbonate with crosslinking agent to get Sevelamer carbonate;
c) optionally drying Sevelamer carbonate maintaining LOD (loss on drying) content in the range of about 5-10%.

Another aspect of the present invention provides process for preparation of Sevelamer carbonate comprising the steps of;
a) interacting allylamine with suitable carbonate source to get allylamine carbonate;
b) converting the obtained allylamine carbonate into polyallylamine carbonate;
c) crosslinking the obtained polyallylamine carbonate to get Sevelamer carbonate;
d) optionally drying Sevelamer carbonate maintaining loss on drying content in the range of about 5-10%.

Another aspect of the present invention provides process for drying carbonate salt of amine polymers at critical conditions to maintain LOD (loss on drying) content in the range of about 5-10%.

Still another aspect of the present invention provides process for preparation of Sevelamer carbonate comprising the steps of;
a) interacting Sevelamer hydrochloride with suitable carbonate source to obtain Sevelamer carbonate;
b) drying Sevelamer carbonate maintaining loss on drying content less than 10%.

According to another aspect of the present invention provides process for preparation of Sevelamer carbonate comprising the steps of;
a) treating Sevelamer hydrochloride with suitable base to obtain Sevelamer base;
b) interacting sevelamer base with suitable carbonate source to obtain Sevelamer carbonate;
c) drying Sevelamer carbonate maintaining loss on drying content less than 10%.

### DETAILED DESCRIPTION OF THE INVENTION

The present invention provides simple and cost effective processes for the preparation of carbonate salt of amine polymers, in particular, Sevelamer carbonate and polyallylamine carbonate.

The present invention discloses a hitherto unreported route for preparation of carbonate salt of amine polymers, more particularly provides one pot process for preparation of Sevelamer carbonate.

One of the several distinctive features of this process is that it can be adapted for a “one pot reaction” as a commercially adoptable, viable and economical strategy for synthesis of carbonate salt of amine polymers. Furthermore, the said “one pot” strategy avoids a lengthy separation and purification process of intermediates, saves time and resources while increasing chemical yield and purity of the desired product.

According to one embodiment of the present invention process for preparation of carbonate salt of amine polymers comprises interaction of allylamine compound with suitable carbonate source.

According to preferred embodiment Sevelamer hydrochloride is interacted with about 0.5-10 w/w of suitable carbonate source more preferably with about 0.5 w/w of suitable carbonate source most preferably with about equimolar amount of suitable carbonate source to get desired carbonate salt. This process is repeated followed by successive water washings to get Sevelamer carbonate with chloride content less than about 0.05%.

Sevelamer carbonate prepared in accordance with the present invention gives residue on ignition less than 0.1% and chloride content less than 0.05% preferably 0.03% and more preferably 0.01%.

The interaction of carbonate source with Sevelamer hydrochloride is carried out upto 24 hours preferably 8 hours more preferably 4-5 hours at temperature in the range of 0-100° C. preferably at 25-75° C. Preferably the treatment of carbonate source is performed at temperature 60-65° C. and at pressure in the range of about 1 to 15 Kg/cm².

According to the present invention carbonate salt of amine polymer, Sevelamer carbonate is prepared by interacting Sevelamer hydrochloride with sodium carbonate in an amount of 0.5 to 5 w/w of Sevelamer hydrochloride or interacting Sevelamer hydrochloride with sodium bicarbonate in an amount of 0.5 to 5 w/w of Sevelamer hydrochloride preferably sodium bicarbonate is used in 1:1 ratio or interacting Sevelamer hydrochloride with carbon dioxide or interacting Sevelamer hydrochloride with dry ice in water as carbonate source at atmospheric pressure.

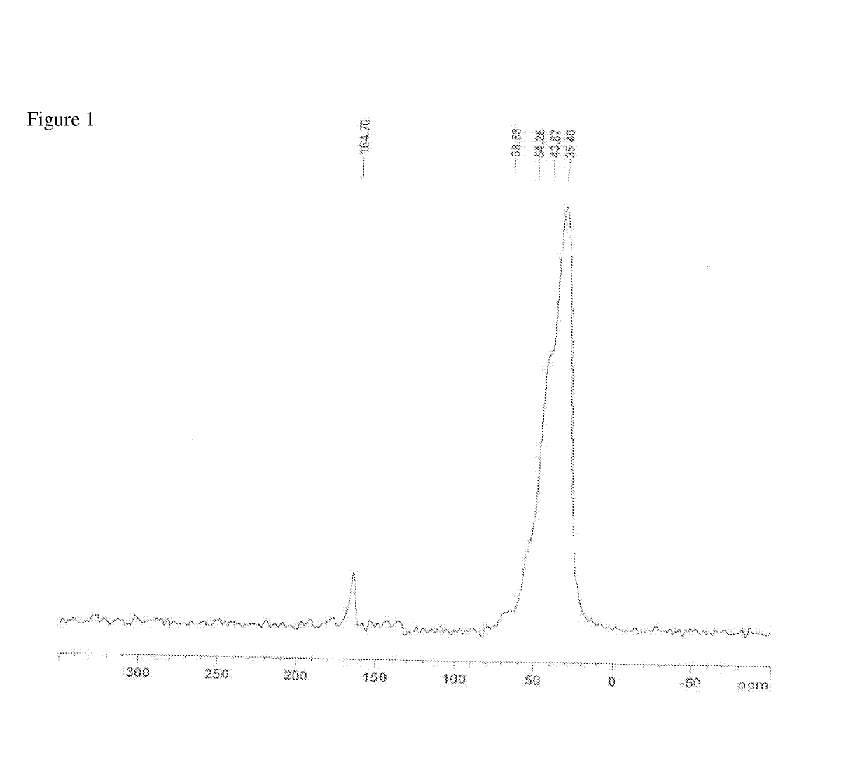

According to one preferred embodiment Sevelamer carbonate is prepared by adding Sevelamer hydrochloride to water and interacting with suitable carbonate source at 0-100° C. preferably treated with carbon dioxide gas at 20-65° C. or treated with sodium carbonate at 25-75° C. or treated with sodium bicarbonate at 25-75° C. more preferably at 60-65° C. for 1-8 hrs with stirring. The material obtained is filtered, washed with water and the wet cake is dried till constant weight of dried polymer is obtained which can be sieved through 30 mesh for uniformity of the sample. Sevelamer carbonate thus obtained has less than 0.05% chloride content and is characterized on Solid state ¹³C NMR which shows prominent peak at 164 ppm which is for carbon of carbonate (FIG. 1).

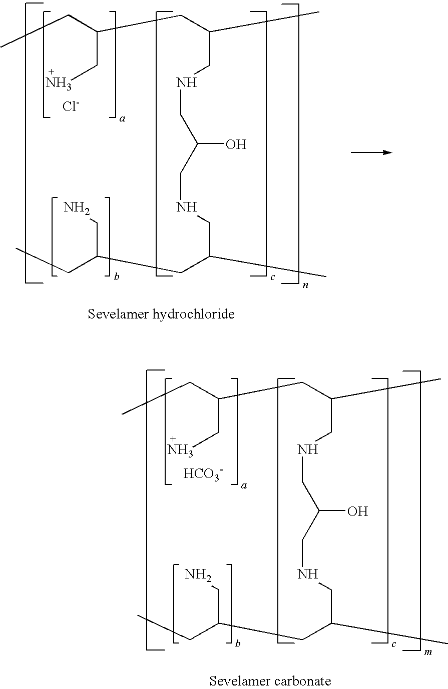

The below Scheme describes the process in accordance with the present invention.

According to second embodiment of the present invention process for preparation of carbonate salt of amine polymer comprises treating allylamine compound with base and interacting the obtained reaction mass with suitable carbonate source to get carbonate salt of amine polymers. The reaction is carried out with or without isolation of Sevelamer base.

In accordance with the invention, Sevelamer hydrochloride is treated with a suitable base in equimolar proportion or in molar excess. The obtained Sevelamer base is interacted with suitable carbonate source to get desired carbonate salt of Sevelamer carbonate. The carbonate source treatment is optionally further repeated to get the desired product with chloride content less than 0.05% preferably 0.01%. By successive water washings, the obtained carbonate salt has residue on ignition less than 0.1%. The obtained carbonate salt of Sevelamer is dried according to the present invention to maintain Loss on drying content in the range of about 5-10%, preferably not less than 5 and not more than 10.

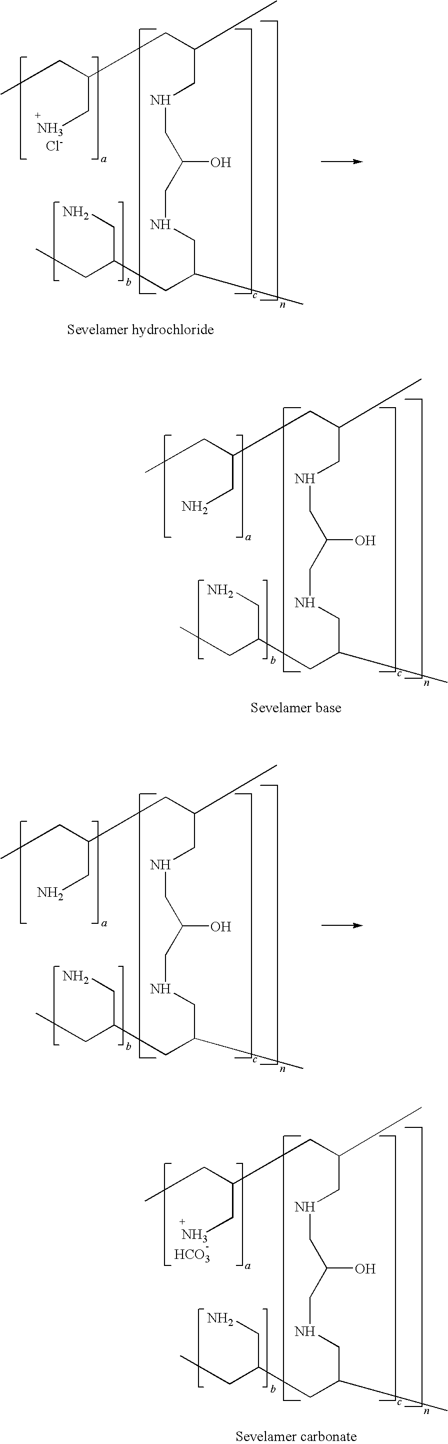

In accordance with one preferred embodiment of the invention, Sevelamer hydrochloride is dispersed in water and sodium hydroxide solution is added to the obtained suspension followed by stirring for 30 minutes. The obtained material is filtered and wet cake is stirred in water for an hour. The material is filtered and the wet cake is washed twice and dried for 5-6 hrs to get Sevelamer base. The obtained Sevelamer is suspended in water, stirred and interacted with suitable carbonate source at 25-35° C. for 8 hrs. The obtained material was filtered and washed with water and the wet cake is dried according to the present invention to get Sevelamer carbonate. Solid state ¹³C NMR shows prominent peak at 164 ppm which is for carbon of carbonate.

According to third embodiment of the present invention process for preparation
a) making polyallylamine from polyallylamine hydrochloride using suitable base;
b) interacting polyallylamine with suitable carbonate source to get polyallylamine carbonate;
c) subjecting to crosslinking the obtained polyallylamine carbonate with suitable crosslinking agent to get Sevelamer carbonate.

In step b) the polyallylamine is treated with suitable carbonate source at 0-100° C. preferably treated with carbon dioxide gas at 20-65° C. or treated with sodium carbonate at 25-75° C. or treated with sodium bicarbonate at 25-75° C. more preferably at 65° C.

Step b) further comprises isolating polyallylamine carbonate from suitable solvent and partially neutralizing with suitable base. The partial neutralization comprises adding 65-75 mole % of base to the solution of polyallylamine carbonate.

In step c) crosslinking is carried out at elevated temperature optionally in presence of emulsifier and/or surfactant to get desired carbonate salt of Sevelamer.

In accordance with one preferred embodiment of the invention, polyallylamine hydrochloride is treated with base in presence of suitable solvent. The inorganic salts formed during the synthesis of polyallylamine base is separated by filtration. The solvent is distilled out from the filtrate and the sticky polymeric mass is dissolved in water and carbon dioxide gas is purged under pressure or at atmospheric pressure to get polyallylamine carbonate. The aqueous solution of polyallylamine carbonate is poured into suitable solvent to get the solid. The separated solid is filtered and the wet cake is dried at an elevated temperature. The polyallylamine carbonate is partially neutralized with base either solid or as aqueous solution in suitable solvent followed by crosslinking using suitable crosslinking agent optionally in presence of emulsifier or surfactant. The obtained carbonate polymer cake is washed with water to remove inorganic salts and the wet cake is dried on rotary evaporator or in Fluidised Bed Dryer (FBD) at an elevated temperature preferably at 25-100° C. The reaction is represented by the following reaction scheme:

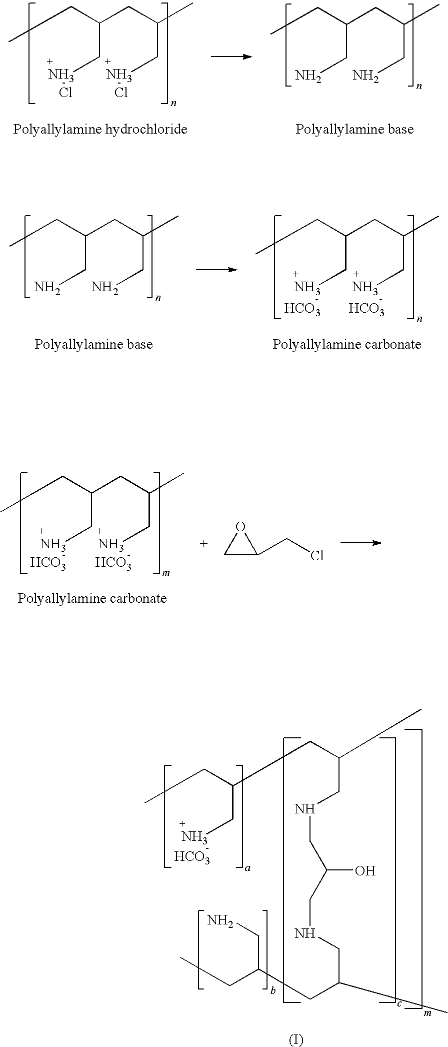

According to fourth embodiment of the present invention process for preparation of Sevelamer carbonate comprises the steps of
a) interacting allylamine with suitable carbonate source to get allylamine carbonate;
b) converting the obtained allylamine carbonate into polyallylamine carbonate and
c) subjecting to crosslinking obtained polyallylamine carbonate with crosslinking agent to get Sevelamer carbonate.

The step b) further comprises isolating polyallylamine carbonate from organic solvent and partially neutralizing polyallylamine carbonate using base. The step c) is optionally carried out in presence of emulsifier and/or surfactant selected from trioleate surfactants such as sorbitan trioleate and sodium dodecyl sulfate and like or mixtures thereof.

In accordance with one preferred embodiment of the invention, allylamine is contacted with suitable carbonate source at 0-100° C. preferably treated with carbon dioxide gas at 20-65° C. or treated with sodium carbonate at 25-75° C. or treated with sodium bicarbonate at 25-75° C. more preferably at 65° C. to get allylamine carbonate. The aqueous solution of allylamine carbonate is then subjected to polymerization in presence of suitable polymerizing agent under inert atmosphere. The aqueous solution of polyallylamine carbonate is added to a suitable solvent to get the polymer which is filtered. The polyallylamine carbonate is partially neutralized with base and suspended in suitable solvent. The suspension is heated to elevated temperature of about 40° C. to about 150° C., preferably 55 to 60° C. followed by treatment with crosslinking agent maintaining elevated temperature till cross linking is complete in presence of emulsifier and/or surfactant. The reaction mixture is cooled at 25° to 35° C. and filtered. The polymer gel is optionally treated with organic solvent and filtered. The carbonate polymer cake is washed with water to remove inorganic salts and the wet cake is dried at an elevated temperature preferably at 50-100° C. to remove any moisture present.

The reaction is represented by the following reaction scheme:

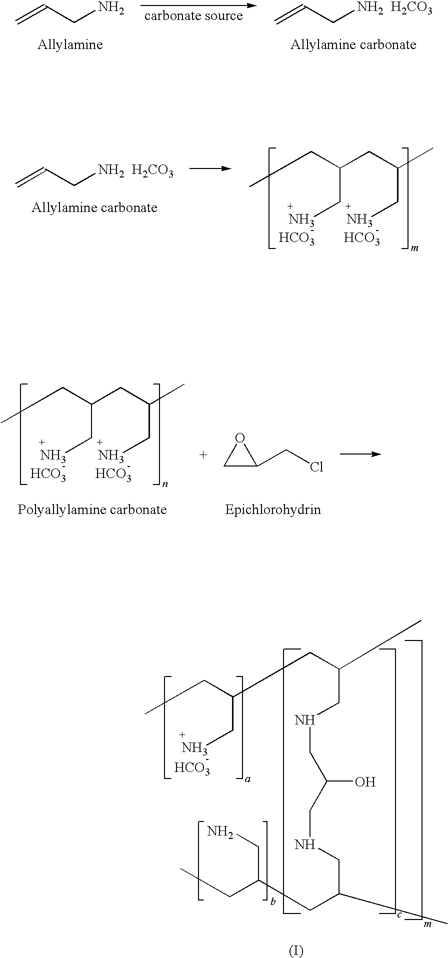

According to fifth embodiment of the present invention there is provided drying process for carbonate salt of amine polymers at critical temperature, time and vacuum conditions to maintain loss on drying content in the range of about 5-10%.

The drying of carbonate salt of amine polymers in accordance with the present invention is performed by controlling the parameters especially time, vacuum and temperature conditions to achieve desired Carbonate content, Chloride content and Loss on drying content in amine polymer carbonate salt.

According to preferred embodiment drying of carbonate salt of polymers is Bed Dryer (FBD) or Rotary evaporator under atmospheric pressure or reduced pressure at elevated temperature for 1 to 48 hours to maintain loss on drying content less than about 10%.

Preferably, drying process for carbonate salt of amine polymers comprises drying at 50-100° C. in air tray dryer (ATD) or at 50-100° C. in vacuum tray dryer (VTD) or at 50-110° C. in Fluidized Bed Dryer (FBD) or 50-100° C. in rotary evaporator.

Sevelamer carbonate obtained according to the present invention has carbonate content from about 3 to about 7 meq/gm preferably about 4 to 6 meq/gm, Phosphate Binding Capacity of about 3 to about 7 mmol/gm and chloride content less than 0.05%, residue on ignition not more than 0.1% and loss on drying not more than 10% preferably not less than about 5%. Sevelamer carbonate obtained according to the present invention is sieved through 30 mesh for uniformity of the sample.

The carbonate source used is selected from carbon dioxide gas, carbonic acid prepared in situ by dissolving carbon dioxide gas in water, by using dry ice for gas generation, carbonate rich water, ammonium bicarbonate, magnesium bicarbonate and carbon dioxide with metal oxides and metal hydroxides, alkali metal or alkaline earth metal salts such as sodium carbonate, potassium carbonate, calcium carbonate, sodium bicarbonate, sodium bicarbonate, potassium bicarbonate, calcium bicarbonate and the like.

The base used is an inorganic or organic base. As the inorganic base, a hydroxide, carbonate orbicarbonate of a metal or the like is preferred. Specific examples thereof include lithium hydroxide, sodium hydroxide, potassiumhydroxide, magnesiumhydroxide, calcium hydroxide, bariumhydroxide, cesiumhydroxide, sodiumcarbonate, potassium carbonate, magnesium carbonate, calcium carbonate, barium carbonate, cesium carbonate, sodium bicar-bonate, potassium bicarbonate and the like. Preferably the base used is selected from is alkali metal or alkaline earth metal salts or alkali hydroxides or mixtures thereof. Any remaining excess base and unwanted salt formed during the process is removed by repeated washing of the final insoluble polymer with sufficient quantity of water under vigorous stirring. The base is used in an amount of 65 to 75 mole % by weight.

The emulsifier or surfactant used is selected from trioleate surfactants, preferably sorbitane trioleate (SPAN-85) or sodium lauryl sulphate and mixtures thereof.

Suitable solvent used is selected from aliphatic or aromatic hydrocarbon, water, alcohols such as methanol, ethanol, isopropanol, butanol and ketones such as acetone or mixtures thereof. The aromatic hydrocarbon are selected from benzene, toluene, xylenes, chlorobenzenes, nitrobenzenes and said aliphatic hydrocarbons are selected from chlorinated methylene chloride, ethylene chloride and the like or mixtures thereof.

The polymerizing agent used is 2,2′-Azobis[2-methyl-N-(2-hydroxyethyl)propionamide (VA-086). The crosslinking agent is epichlorohydrin used in the range of about 5% to about 12% by weight of Polyallylamine carbonate.

While the present invention has been described in terms of its specific embodiments, certain modifications and equivalents will be apparent to those skilled in the art and are included within the scope of present invention. The examples are provided to illustrate particular aspects of the disclosure and do not limit the scope of the present invention.

### EXAMPLES

### Example 1

100 gm Sevelamer hydrochloride was dispersed in 500 ml purified water and sodium hydroxide solution [20 gm sodium hydroxide dissolved in 500 ml purified water] was added to the obtained suspension followed by stirring at 25-35° C. for 30 minutes. The obtained material was filtered and wet cake was stirred in 1.0 L purified water for an hour. The material was filtered and cake was washed twice. Wet cake was dried at 50-90° C. for 5-6 hrs to get Sevelamer base (70 gm). LOD: 0.4% Chloride content: Nil.

### Example 2

10 gm Sevelamer was suspended in 200 ml water and stirred. Carbon dioxide gas was purged into the obtained suspension at 25-35° C. for 8 hrs using dry ice. The obtained material was filtered and washed with 100 ml water [3×100] and the wet cake was dried on rotavapor at 90-95° C. to get Sevelamer carbonate (11.5 gm). Yield—115% w/w [Chloride content: 0.3%, Phosphate binding: 5.75 mMole/g, Carbonate content: 4.78 meq/g and Degree of crosslinking—16.4%], Solid state ¹³C NMR shows prominent peak at 164 ppm which is for carbon of carbonate.

### Example 3

10 gm Sevelamer was added to 200 ml water and reacted with carbon dioxide gas under pressure at 25-35° C. for 7-8 hrs with stirring. The obtained material was filtered and washed with 100 ml water thrice [3×100]. The wet cake thus obtained was dried on rotavapor at 90-95° C. to get Sevelamer carbonate (11.3 gm). Yield—113% w/w Degree of crosslinking—16.4%, Solid state ¹³C NMR shows prominent peak at 164 ppm which is for carbon of carbonate.

### Example 4

Sevelamer (7 gm) was added to 150 ml water and reacted with carbon dioxide gas under pressure at 60-65° C. for 7-8 hrs with stirring. The material obtained was filtered and washed with 100 ml purified water thrice [3×100]. The wet cake thus obtained was dried on rotavapor at 90-95° C. to get Sevelamer carbonate (9.3 gm).

Yield—120% w/w Degree of crosslinking—16.4%, Solid state ¹³C NMR shows prominent peak at 164 ppm which is for carbon of carbonate.

### Example 5

Sevelamer (7 gm) was added to 150 ml water and reacted with carbon dioxide gas by purging under pressure at 60-65° C. for 7-8 hrs with stirring. The material obtained was filtered and washed with 100 ml purified water thrice [3×100]. The wet cake thus obtained was dried on rotavapor at 90-95° C. to get Sevelamer carbonate (9.0 gm).

[Degree of crosslinking—16.4%, Chloride content: 0.5%, Phosphate binding: 5.56 mMole/g and Carbonate content: 4.46 meq/g] Yield—110% w/w Solid state ¹³C NMR shows prominent peak at 164 ppm which is for carbon of carbonate.

### Example 6

Sevelamer hydrochloride (10 gm) was treated Sodium hydroxide solution (2M) for 1 hr at temperature 25 to 35° C. to get Sevelamer base. Filter the free base and was added to 150 ml water and reacted with carbon dioxide gas by purging under pressure at 60-65° C. for 7-8 hrs with stirring. The material obtained was filtered and washed with 100 ml purified water thrice [3×100]. The wet cake thus obtained was dried on rotavapor under vacuum at 90-95° C. to get Sevelamer carbonate (9.3 gm). Yield—120% w/w.

[Degree of crosslinking—16.4%, Chloride content: 0.2%, Phosphate binding: 5.45 mMole/g and Carbonate content: 4.36 meq/g].

Solid state ¹³C NMR shows prominent peak at 164 ppm which is for carbon of carbonate.

### Example 7

Sevelamer hydrochloride (10 gm) was treated sodium hydroxide solution (2M) for 1 hr at temperature 25 to 35° C. to get Sevelamer base. Filter the free base and was added to 100 ml water. Sodium bicarbonate (10 gm dissolved in 1000 ml purified water) solution was added at temperature 60-65° C. for 4 hrs with stirring. Sevelamer Carbonate thus obtained was filtered and again subjected to for treatment of sodium bicarbonate solution (10 gm in 1000 ml). Reaction mixture was heated for 4 hrs at 60-65° C. with stirring. The material obtained was filtered and washed with 100 ml purified water thrice [3×100]. The wet cake thus obtained was dried under vacuum tray dryer at 80-90° C. for 24 hrs and further dried in atmospheric tray dryer at 100° C. for 36 hrs to get Sevelamer carbonate (9.0 gm). The loss of drying of material was about 5-7% achieved as per requirement. Yield—120% w/w, [Degree of crosslinking—16.4%, Chloride content: 0.01%, Phosphate binding: 5.68 mMole/g and Carbonate content: 4.85 meq/g]

### Example 8

Sodium hydroxide pellets (41 gm) is dissolved in 600 ml methanol at 25-35° C. and polyallylamine hydrochloride (100 gm) is added to it followed by stirring for 5-6 hrs at temperature 25-35° C. The obtained reaction mass is filtered through hyflobed and filtrate is concentrated to reduce to half volume and the separated inorganic salt is filtered off over hyflobed. The obtained filtrate is concentrated completely under vacuum to get sticky mass (61 gm) of polyallylamine. Yield—61% w/w

### Example 9

Polyallylamine (27.5 gm) dissolved in 100 ml water is charged into 1 L SS 316 autoclave and interacted with carbon dioxide gas under pressure (5.0 Kg/cm²). Initially 2-3 Kg/cm2 gas is consumed by the reaction mass and exotherm is observed from 28 C to 35° C. Then 5 Kg/cm² pressure is maintained for 5-6 hours. After completion of the reaction the reaction mass is slowly added to 700 methanol and stirred for 3-4 hours. The separated solid (31 gm) is filtered, washed with 50 ml methanol and dried at 40-50° C. in vacuum oven. Yield—112% w/w

### Example 10

Polyallylamine carbonate (20 gm) is dissolved in 30 ml water and cooled at 5-15° C. under stirring. The aqueous sodium hydroxide solution [dissolving 4.23 gm sodium hydroxide pellets into 4.2 ml of water] is added to reaction mass dropwise at 10-15° C. with continued stirring for 30 minutes. 101 ml toluene and 0.6 ml SPAN-85 is added to it and heated at 55-60° C. Epichlorohydrin (1.06 gm) is added to the reaction mass followed by stirring and heating for 3 hrs. The reaction mass is cooled at 25-35° C. and filtered through Buchner funnel. The obtained wet cake is added to 1 L acetone followed by stirring for 1 hour to get solid which was filtered through Buchner funnel. The aqueous organic washings are repeated for 7-10 times till polymer is free from excess alkalinity and the obtained wet cake is dried at 40-50° C. on rotavapor and then at 90-95° C. till constant weight of polymer is obtained (9 gm). Yield—45% w/w, Solid state ¹³C NMR shows prominent peak at 164 ppm which is for carbon of carbonate.

### Example 11

Polyallylamine carbonate (20 gm) is dissolved in 30 ml water and cooled at 5-15° C. under stirring. The aqueous sodium hydroxide solution [dissolving 4.23 gm sodium hydroxide pellets into 4.2 ml of purified water] is added to obtained reaction mass dropwise at 10-15° C. with continued stirring for 30 minutes. 150 ml water and 0.6 ml SPAN-85 is added to it and heated at 60-80° C. Epichlorohydrin (1.06 gm) is added followed by stirring and heating is continued for 3 hours. The reaction mass is cooled at 25-35° C. and filtered through Buchner funnel. The obtained wet cake is added to 1 L acetone followed by stirring for 1 hour to get solid which is filtered through Buchner funnel. This aqueous organic washings are repeated for 7-10 times till the polymer is free from excess alkalinity and the obtained material is dried at 40-50° C. on rotavapor and/or Fluidised bed dryer then at 90-95° C. till constant weight of polymer is obtained (9 gm).

### Example 12

Polyallylamine carbonate (20 gm) is dissolved in 30 ml water and cooled at 5-15° C. under stirring. The aqueous sodium hydroxide solution [dissolving 4.23 gm sodium hydroxide pellets into 4.2 ml of purified water] is added to the obtained reaction mass dropwise at 10-15° C. with continued stirring for 30 minutes. 150 ml water and 0.6 ml SPAN-85 is added to it and heated at 60-80° C. Epichlorohydrin (1.06 gm) is added followed by stirring and heating is continued for 3 hours. The reaction mass is cooled at 25-35° C. and filtered through Buchner funnel. The obtained wet cake is added to 1 L isopropyl alcohol (IPA) followed by stirring for 1 hour to get solid which is filtered through Buchner funnel. The obtained material is washed with water and organic solvents for 4-5 times till the polymer is free from excess alkalinity. The obtained wet cake is dried under vacuum tray dryer at 80-90° C. for 24 hrs and further dried in atmospheric tray dryer at 100° C. for 36 hrs till constant weight of dried polymer is obtained (15 gm). The loss on drying of material is around 6% as per requirement.

### Example 13

In 1 L SS 316 autoclave, 75 gm allylamine and 200 ml water is charged and carbon dioxide gas under pressure (5 Kg/cm2) is purged into autoclave for 3-4 hours followed by stirring. Nitrogen gas is purged for 15 minutes. 9.8 gm VA-086 is added to the reaction mass and stirred at 70-80° C. for 12 hours and this solution is added to 1 L methanol under stirring. The separated material is filtered and washed with 100 ml methanol, suck dried and dried in vacuum oven at 50-60° C. to get 90 gm of polyallylamine carbonate. Yield—120% w/w

### Example 14

Polyallylamine carbonate (20 gm) dissolved in 30 ml water is cooled at 5-15° C. under stirring and sodium hydroxide solution [dissolving 4.23 gm sodium hydroxide pellets into 4.2 ml of purified water] is added to the obtained reaction mass dropwise at 10-15° C. followed by continued stirring for 30 minutes. 101 ml toluene and 0.6 ml SPAN-85 is added to it and heated at 55-60° C. Epichlorohydrin (1.06 gm) is added and reaction mass is stirred and heated for 3 hours. Then it is cooled to 25-35° C. and filtered through Buchner funnel. The wet cake obtained is added to 1 to 1.5 L acetone followed by stirring for 1 hour to get solid which is filtered through Buchner funnel. The washings are repeated for 7-10 times till polymer is free from excess alkalinity. Wet cake (9 gm) is dried at 40-50° C. on rotavapor and then at 90-95° C. till constant weight of polymer is obtained. Yield—45% w/w

### Example 15

Sevelamer hydrochloride (10 gm) was added to 10% aqueous sodium bicarbonate solution at 25-35° C. and stirred for 7-8 hrs. The material obtained was filtered and washed with 100 ml purified water thrice and the wet cake was dried on rotavapor at 90-95° C. to get Sevelamer carbonate (7.5 gm). Yield—75% w/w

Solid state ¹³C NMR shows prominent peak at 164 ppm which is for carbon of carbonate.

[Chloride content: 0.4%, Phosphate binding: 5.45 mMole/g and Carbonate content: 4.85 meq/g]

### Example 16

Sevelamer hydrochloride (10 gm) was added to 10% aqueous sodium bicarbonate solution. The mixture was stirred at 60-65° C. for 4 hrs. The material obtained was filtered and the obtained wet cake was again subjected to the treatment of 10% sodium bicarbonate solution. Reaction mixture was heated for 4 hrs at 60-65° C. with stirring. The material obtained was filtered and washed with 100 ml purified water four times and the wet cake was dried on rotavapor under vacuum at 90-95° C. to get Sevelamer carbonate (7.5 gm). Yield—75% w/w, Solid state ¹³C NMR shows prominent peak at 164 ppm which is for carbon of carbonate, [Chloride content: 0.03%, Phosphate binding: 5.25 mMole/g and Carbonate content: 4.65 meq/g].

### Example 17

Sevelamer hydrochloride (10 gm) was added into 130 ml solution of sodium bicarbonate (10 gm NaHCO3 in 130 ml water) and the mixture was stirred at 60-65° C. for 4 hrs. The material was filtered using Buckner funnel assembly. The obtained wet cake was added into 130 ml solution of sodium bicarbonate (10 gm NaHCO3 in 130 ml water) and stirred at 60-65° C. for 4 hrs. The material was filtered using Buckner funnel assembly and the wet cake was washed by stirring it in 100 ml water for 1 hr at 60-65° C. The material was filtered using Buckner funnel assembly. The wet cake was washed twice at 60-65° C. and dried on rotavapor at 90-95° C. to get Sevelamer carbonate (8.5 gm). Yield—75% w/w, Chloride content: 0.03%

### Example 18

Sevelamer hydrochloride (1.1 Kg) was added into 15.5 L solution of sodium bicarbonate (1.1 Kg NaHCO₃ in 14.3 L water). The obtained mixture was stirred at 60-65° C. for 4 hrs. The obtained material was filtered by centrifuge filter. The obtained wet cake was added into 15.5 L solution of sodium bicarbonate (1.1 Kg NaHCO₃ in 14.3 L water) and maintained stirring at 60-65° C. for 4 hrs. The material was filtered by centrifuge filter assembly and obtained wet cake was stirred in 11 L water for 1 hr at 60-65° C. The material was filtered by centrifuge filter and the washing of wet cake was repeated at 60-65° C. for two more times. The obtained wet cake was dried in air tray dryer (ATD) at 90-100° C. for 30-36 hrs and LOD was checked after every five hours till LOD was in the range of 5 to 10%. to get Sevelamer carbonate (0.995 Kg), [Chloride content: 0.03%, Phosphate binding capacity: 5.5 mmole/gm, Carbonate content: 5.1 meq/gm]

### Example 19

Sevelamer hydrochloride (10 gm) was added to sodium bicarbonate solution (10 gm in 200 ml) at 25-35° C. The reaction mixture was heated for 4 hrs at 60-65° C. with stirring. Sevelamer Carbonate thus obtained was filtered and again subjected to treatment of Sodium bicarbonate solution (10 gm in 200 ml). Reaction mixture was heated for 4 hrs at 60-65° C. with stirring. The material was filtered off and washed with 100 ml purified water four times (4×100 ml) and the wet cake was dried under vacuum tray dryer at 80-90° C. for 24 hrs and further dried in atmospheric tray dryer at 100° C. for 36 hrs till constant weight of dried polymer was obtained. The loss on drying of material was around 6% (Limit: 4-10%), achieved as per requirement. Sevelamer carbonate (7.5 gm) was obtained which can be sieved through 30 mesh for uniformity of the sample. Yield—75% w/w. Solid state ¹³C NMR shows prominent peak at 164 ppm which is for carbon of carbonate. [Chloride content: 0.02%, Phosphate binding: 5.56 mMole/g and Carbonate content: 4.74 meq/g].

### Example 20

10 g wet cake of Sevelamer carbonate was subjected to drying in air tray dryer at 80-100° C. at atmospheric pressure for 36 hours and LOD was measured after every five hours. LOD: 7.5% Yield: 3.1 gm

### Example 21

100 g wet cake of Sevelamer carbonate was subjected to drying in air tray dryer at 80-100° C. at atmospheric pressure for 37 hours and LOD was measured. LOD: 8.4% Yield: 30 gm

### Example 22

10 g wet cake of Sevelamer carbonate was subjected to drying in vacuum tray dryer at 50-100° C. at reduced pressure for 24 hours and LOD was measured. LOD: 8.5% Yield: 3.2 gm

### Example 23

100 g wet cake of Sevelamer carbonate was subjected to drying in vacuum tray dryer at 50-100° C. at reduced pressure for 24 hours and LOD was measured. LOD: 8.9% Yield: 31 gm

### Example 24

10 Kg wet cake of Sevelamer carbonate was subjected to drying in fluidized bed dryer at 80-100° C. for 16 hours and LOD was measured after every five hours. LOD: 7.9% Yield: 3.4 kg

### Example 25

15 Kg wet cake of Sevelamer carbonate was subjected to drying in fluidised bed dryer at 80-110° C. for 16 hours and LOD was measured. LOD: 8.8% Yield: 4.9 kg.

### Example 26

10 g wet cake of Sevelamer carbonate was subjected to drying in rotary evaporator at 50-100° C. at reduced pressure for 16 hours and LOD was measured after every five hours.

LOD: 9.1% Yield: 3.1 gm

### Example 27

100 g wet cake of polyallylamine carbonate is subjected to drying in rotary evaporator at 50-100° C. at reduced pressure for 16 hours and LOD is measured. LOD: 8.9% Yield: 33 gm.

### ADVANTAGES OF THE PRESENT INVENTION

a) It provides a simple and economically significant process for preparation of salt of amine polymers particularly Sevelamer carbonate and polyallylamine carbonate.
b) It provides one pot process for preparation of Sevelamer carbonate.
c) It provides carbonate salt of crosslinked polyallylamine polymer having carbonate content from about 3 to about 7 meq/gm, Phosphate Binding Capacity of about 3 to about 7 mmol/gm and chloride content not more than 0.05%, residue on ignition not more than 0.1% and loss on drying not more than 10% as per ICH requirement.
d) It provides a drying process for salts of crosslinked polymers to maintain loss on drying (LOD) less than 10% preferably not less than 5%.
e) It provides Sevelamer carbonate having chloride content less than 0.05%, preferably 0.03% and more preferably 0.01%.
f) It provides process to get Sevelamer carbonate with LOD content not less than 5% to avoid decomposition of the product.

The above description is not intended to detail all modifications and variations of the invention. It will be appreciated by those skilled in the art that changes can be made to the embodiments described above without departing from the inventive concept. It is understood, therefore, that the invention is not limited to the particular embodiments described above, but is intended to cover modifications that are within the spirit and scope of the invention, as defined by the language of the following claims.

We claim:

1. A process for preparation of carbonate salt of amine polymers comprising interacting allylamine compound with suitable carbonate source.

2. A process for preparation of carbonate salt of amine polymers as claimed in claim 1 comprising interacting allylamine compound with about 0.5-5 w/w of suitable carbonate source with respect to allylamine compound.

3. A process for preparation of carbonate salt of amine polymers as claimed in claim 2 comprising interacting allylamine compound with about 2.5 w/w of suitable carbonate source with respect to allylamine compound.

4. A process for preparation of carbonate salt of amine polymers as claimed in claim 3 comprising interacting allylamine compound with about 1.5 w/w of suitable carbonate source with respect to allylamine compound.

5. A process for preparation of carbonate salt of amine polymers as claimed in claim 4 comprising interacting allylamine compound with equimolar amount of suitable carbonate source with respect to allylamine compound.

6. The process as claimed in claim 1 wherein said allylamine compound comprises allylamine, polyallylamine, Sevelamer and Sevelamer hydrochloride.

7. The process as claimed in claim 1 wherein said salt of amine polymers is Sevelamer carbonate.

8. The process as claimed in claim 1 wherein said interaction is carried out in 24 hours.

9. The process as claimed in claim 8 wherein said interaction is performed under atmospheric pressure.

10. The process as claimed in claim 9 wherein said interaction is performed at temperature in the range of 0-100° C.

11. The process as claimed in claim 10 wherein said reaction is performed preferably at 25-35° C.

12. The process as claimed in claim 10 wherein said reaction is performed more preferably at 60-65° C.

13. A process for drying carbonate salt of amine polymers.

14. The process as claimed in claim 13 said drying is performed in air tray dryer (ATD) or vacuum tray dryer (VTD) or Fluidized Bed Dryer (FBD) or rotary evaporator to maintain loss on drying content less than about 10% and not less than about 5%.

15. The process as claimed in claim 14 wherein said drying is carried out at elevated temperature for 1 to 48 hours.

16. The process as claimed in claim 7 wherein said Sevelamer carbonate is dried at 80-100° C. under atmospheric pressure in air tray dryer (ATD).

17. The process as claimed in claim 7 wherein said Sevelamer carbonate is dried at 50-100° C. in vacuum tray dryer (VTD).

18. The process as claimed in claim 7 wherein said Sevelamer carbonate is dried at 80-110° C. in Fluidized Bed Dryer (FBD).

19. The process as claimed in claim 7 wherein said Sevelamer carbonate is dried at 50-100° C. in rotary evaporator.

20. A process for preparation of Sevelamer carbonate comprising
a) making polyallylamine from polyallylamine hydrochloride using suitable base
b) treating polyallylamine with suitable carbonate source to get polyallylamine carbonate
c) subjecting to crosslinking the obtained polyallylamine carbonate with suitable crosslinking agent optionally in presence of emulsifier and/or surfactant to get Sevelamer carbonate

21. The process as claimed in claim 20 wherein polyallylamine base is treated with carbon dioxide gas in water at 25-65° C.

22. The process as claimed in claim 20 wherein polyallylamine base is treated with sodium carbonate at 25-75° C.

23. The process as claimed in claim 20 wherein polyallylamine base is treated with sodium bicarbonate at 25-75° C.

24. The process as claimed in claim 20 step b) further comprises isolating polyallylamine carbonate from suitable solvent and partially neutralizing with suitable base.

25. The process as claimed in claim 24 wherein said partial neutralization comprises adding 65-70 mole % of base to the solution of polyallylamine carbonate in suitable solvent.

26. The process as claimed in claim 25 wherein said solvent is selected from benzene, toluene, xylenes, chlorobenzenes, nitrobenzenes and said aliphatic hydrocarbons are selected from chlorinated methylene chloride and ethylene chloride, water or mixtures thereof.

27. The process as claimed in claim 20 wherein said emulsifier is sorbtian trioleate and said surfactant is sodium dodecyl sulfate and like.

28. The process as claimed in claim 20(c) wherein said crosslinking is carried out at elevated temperature.

29. Carbonate salt of amine polymer having carbonate content from about 3 to about 7 meq/gm, Phosphate Binding Capacity of about 3 to about 7 mmol/gm and chloride content not more than 0.05%, residue on ignition not more than 0.1% and loss on drying not more than 10%.

30. Sevelamer carbonate having less than 0.05% chloride content.

31. The process for preparation of Sevelamer carbonate comprising
a) treating allylamine with suitable carbonate source to get allylamine carbonate;
b) converting the obtained allylamine carbonate into polyallylamine carbonate;
c) crosslinking obtained polyallylamine carbonate with crosslinking agent optionally in presence of emulsifier/surfactant;
d) isolating Sevelamer carbonate

32. The process as claimed in claim 31 wherein step b) further comprises isolating polypallylamine carbonate from organic solvent.

33. The process as claimed in claim 31 further comprises partially neutralizing polyallylamine carbonate using base.

34. The process as claimed in claim 31 wherein said emulsifier/surfactant used is selected from trioleate surfactants and sorbitane trioleate.

35. A process for preparation of Sevelamer carbonate comprising contacting Sevelamer hydrochloride with suitable carbonate source.

36. The process as claimed in claim 35 wherein said treatment of carbonate source is performed at 25-75° C.

37. The process as claimed in claim 35 wherein Sevelamer hydrochloride is treated with sodium carbonate.

38. The process as claimed in claim 37 wherein said sodium carbonate is used in an amount of 0.5 to 5 w/w of Sevelamer hydrochloride.

39. The process as claimed in claim 35 wherein Sevelamer hydrochloride is treated with sodium bicarbonate.

40. The process as claimed in claim 39 wherein said sodium bicarbonate is used in an amount in the range of 0.5 to 5 w/w of Sevelamer hydrochloride.

41. The process as claimed in claim 40 wherein said sodium bicarbonate is used in 1:1 ratio.

42. The process as claimed in claim 35 wherein optionally Sevelamer hydrochloride is further treated with sodium bicarbonate to get Sevelamer carbonate with chloride content below 0.05%

43. The process as claimed in claim 35 wherein Sevelamer hydrochloride is treated with carbon dioxide at pressure in the range of about 1 to 15 Kg/cm².

44. A process for preparation of Sevelamer carbonate comprising contacting Sevelamer hydrochloride with suitable base to get Sevelamer base and treating obtained Sevelamer base with suitable carbonate source to get Sevelamer carbonate.

45. The process as claimed in any of the preceding claims wherein said carbonate source is selected from carbon dioxide gas, carbonic acid prepared in situ by dissolving carbon dioxide gas in water or dry ice, carbonate salts of alkali metal or alkaline earth metal salts.

46. The process as claimed in any of the preceding claims wherein said base is alkali metal or alkaline earth metal salts comprising sodium carbonate, potassium carbonate, calcium carbonate, sodium bicarbonate and sodium hydroxide in solid or solution form.

47. Sevelamer carbonate as claimed in claim any of the preceding claims wherein the drying and packing of material is done in such way to control the Loss on drying below 10%.
